(19) United States
(12) Patent Application Publication
(10) Pub. No.: US 2010/0025471 A1
(43) Pub. Date: Feb. 4, 2010

(54) BARCODE READING MECHANISM, READING METHOD, AND SUBSTRATE PROCESSING APPARATUS

(75) Inventors: Satoshi Nakazawa, Kamiminochi (JP); Tadashi Inoue, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki-shi (JP)

(21) Appl. No.: 12/508,168

(22) Filed: Jul. 23, 2009

(30) Foreign Application Priority Data
Jul. 29, 2008 (JP) 2008-195328

(51) Int. Cl. G06K 7/10

(52) U.S. Cl. 235/462.01

(57) ABSTRACT

A barcode reading apparatus include a barcode reader for reading a barcode, a moving mechanism for defining a movement position of the barcode reader in a plane, an angle adjusting mechanism for adjusting a reading angle of the barcode reader in a direction orthogonal to a longitude direction of the barcode, a controller for controlling the moving mechanism upon reading the barcode to adjust a position of the barcode reader to a barcode reading position, and controlling the angle adjusting mechanism in the adjusted position to adjust the reading angle of the barcode reader.

### CROSS REFERENCE TO RELATED APPLICATION

This application is based upon and claims the benefit of priority from the prior Japanese Patent Application NO. 2008-195328 filed on Jul. 29, 2008, the entire contents of which are incorporated herein by reference.

### FIELD

The embodiments discussed herein are related to a barcode reading mechanism and method that can securely read a barcode embedded in a work such as a substrate, and a substrate processing apparatus having the barcode reading mechanism.

### BACKGROUND

A manufacturing process for a wiring substrate involves processing for specifying a substrate and managing a manufacturing history of the substrate for process management. To specify a substrate, a product number or the like is assigned to each substrate. To facilitate management, however, a barcode is embedded in a substrate to manage the substrate.

To describe a general method for reading a barcode, a barcode reader using laser light or the like is used.(Japanese Laid-open Patent Publication No. 2002-222387 and Japanese Laid-open Patent Publication No. 8-30716)

In the case where a barcode is formed on the substrate surface through laser processing, there arises a problem that the barcode might not be read easily depending on a shape of the substrate surface. For example, a contrast of the barcode may increase or decrease depending on a state of a resin film formed on the substrate surface. The increase of the contrast of the barcode and the decrease of the contrast of the bar code make reading of the barcode difficult.

The barcode appears in various forms due to various factors such as a color, surface roughness, film thickness, etc. of a resin film. A subtle lot-to-lot difference occurs such that a barcode appears in different forms even if the same product is used.

Although a barcode is generally read in an automated manner, if the barcode is difficult to correctly read, a product number or the like is manually input. Therefore, in a process for reading and processing a barcode, it is very important to correctly read the barcode from the viewpoint of increasing operation efficiency.

### SUMMARY

According to an aspect of the embodiments, a barcode reading apparatus includes: a barcode reader for reading a barcode; a moving mechanism that defines a movement position of the barcode reader in a plane; an angle adjusting mechanism for adjusting a reading angle of the barcode reader in a direction orthogonal to a longitudinal direction of the barcode; and a controller for controlling the moving mechanism upon reading the barcode to adjust a position of the reading unit to a barcode reading position, and controlling the angle adjusting mechanism in the adjusted position to adjust the reading angle of the reading unit.

The object and advantages of the embodiments will be realized and attained by means of the elements and combinations particularly pointed out in the claims.

It is to be understood that both the foregoing general description and the following detailed description and are exemplary and explanatory and are not restrictive of the embodiments, as claimed.

### BRIEF DESCRIPTION OF THE DRAWINGS

FIG. 1 is a perspective view of a substrate processing apparatus equipped with a barcode reading mechanism;

FIG. 2 is a front view of a substrate processing apparatus equipped with a barcode reading mechanism;

FIG. 3 is a front view of a router processing unit and a barcode reading unit;

FIG. 4 illustrates a mounting mechanism of a barcode reading unit;

FIG. 5 is a flowchart of an operation for reading a barcode; and

FIG. 6 is a graph showing results of measuring a barcode reading rate with varying reading angles of a reading unit.

### DESCRIPTION OF THE PREFERRED EMBODIMENTS

Hereinafter, embodiments of a barcode reading mechanism, a reading method, and a substrate processing apparatus equipped with the barcode reading mechanism will be described.

### (Substrate Processing Apparatus)

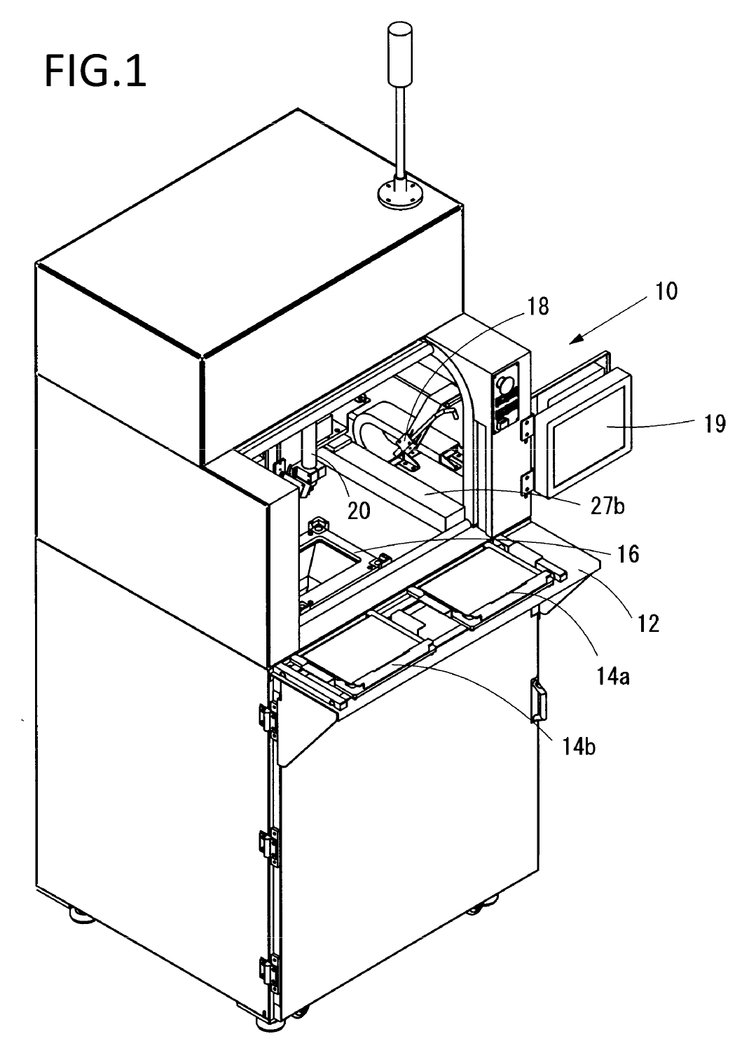

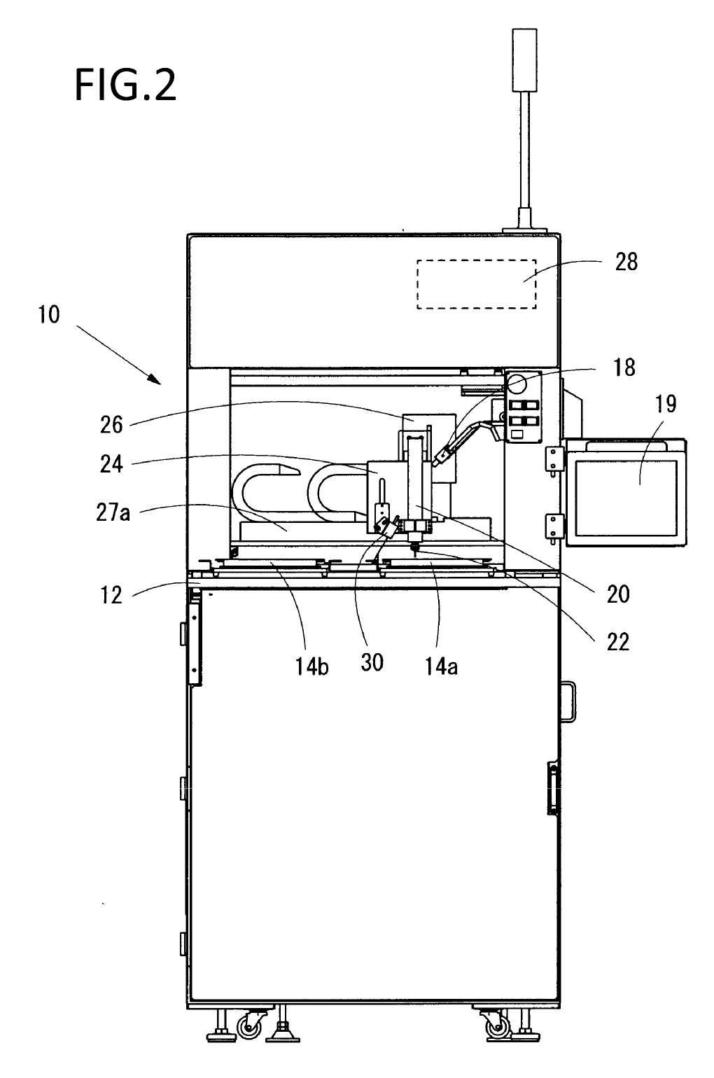

FIGS. 1 and 2 are perspective and front views showing the overall structure of a substrate processing apparatus having a barcode reading mechanism. The substrate processing apparatus is used in processing for dicing a single substrate into plural substrates. To be specific, connection between substrates to be separated is cut through router processing to thereby obtain separated substrates.

A processing chamber 10 for processing a substrate is positioned in the upper half of the apparatus, and the processing chamber 10 accommodates a router processing unit 20. The router processing unit 20 includes a chuck portion 22 for supporting a router bit, and a driving unit for rotating the router bit. The router processing unit 20 is movable to an arbitrary position in an X direction (lateral direction in FIG. 2) and a Y direction (front-to-back direction with respect to the front side of the apparatus) by an X driving mechanism and a Y driving mechanism as moving mechanisms.

In the processing apparatus according to an embodiment, an X driving mechanism 27a is provided on the back side of the processing chamber 10 with its longitudinal direction being aligned with the lateral direction (see FIG. 2), and a Y driving mechanism 27b is provided on the right side in the processing chamber 10 with its longitudinal direction being aligned with the front-to-back direction (see FIG. 1). The X driving mechanism 27a and the Y driving mechanism 27b both include a ball screw, a slide guide, and a driving servo motor. The X driving mechanism 27a is supported on the Y driving mechanism 27b. As shown in FIG. 2, a supporting block 26 is fixed onto the X driving mechanism 27a, and the router processing unit 20 is mounted to the supporting block 26 through a supporting plate 24. With this structure, the router processing unit 20 is movable to an arbitrary position in a plane.

The front side of the processing chamber 10 is opened, and a support shelf 12 extends forward from a front edge of the opening in a horizontal direction, and trays on which setting pallets 14a and 14b are set, are arranged on both sides of the support shelf 12. A substrate to be processed is conveyed while supported on the pallets. FIG. 1 shows a state in which the pallets 14a and 14b are set on the trays.

A setting unit 16 for supporting a substrate in a processing position is defined on the bottom of the processing chamber 10. Processing for cutting a substrate is carried out by carrying the pallets 14a and 14b having the substrate supported thereon into the setting unit 16 one by one.

At the time of cutting a substrate in the setting unit 16, an ionizer 18 provided in an upper position of the processing chamber 10 is driven to process the substrate while ionizing the substrate.

An operation for carrying in/out the substrate is performed from right side of the tray and left side of the tray by turns and separated substrates are discharged together with the pallets. Then, new substrates are successively supplied.

An operation touch panel 19 is provided on the front side of the apparatus. Various input operations and control operations are performed using the panel.

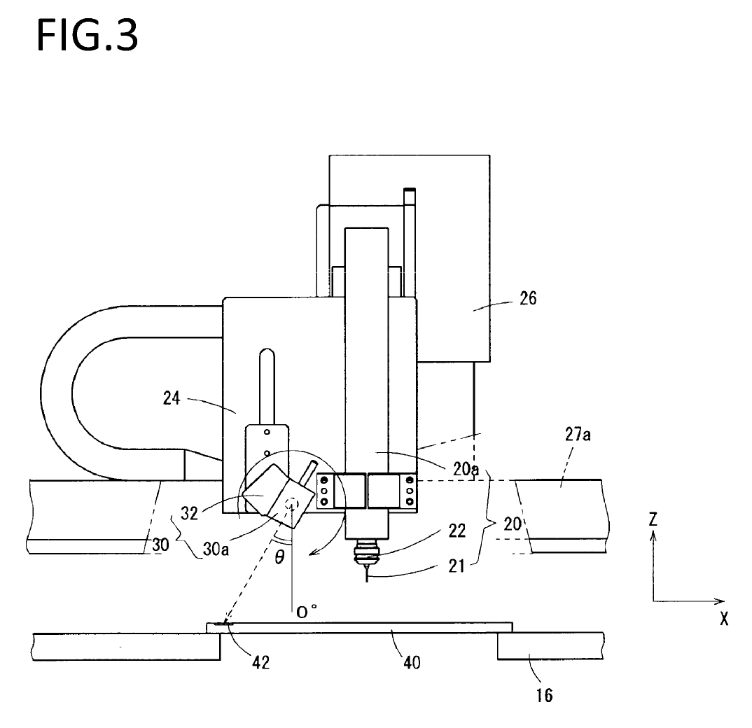

FIG. 3 is a front view of the router processing unit 20 and a barcode reading unit 30 under such a condition that a substrate 40 is set in the setting unit 16.

In the substrate processing apparatus of this embodiment, the barcode reading unit 30 is attached to the supporting plate 24 supporting the router processing unit 20 movably supported in an arbitrary position in a plane by the moving mechanism, and an in-plane movement position of the barcode reading unit 30 is controlled by use of the moving mechanisms of the router processing unit 20.

As described above, the router processing unit 20 is supported with its main body 20a fixed to the supporting plate 24. The supporting plate 24 is supported to the supporting block 26 movably in a vertical direction (movable in a Z direction) with the plate surface being set in a vertical direction. The router processing unit 20 includes a router bit 21, the chuck portion 22, and a main body 20a incorporating the driving unit.

The barcode reading unit 30 is attached to the supporting plate 24 such that the unit is flush with the surface of the supporting plate 24 on which the router processing unit 20 is attached, with a variable reading angle θ.

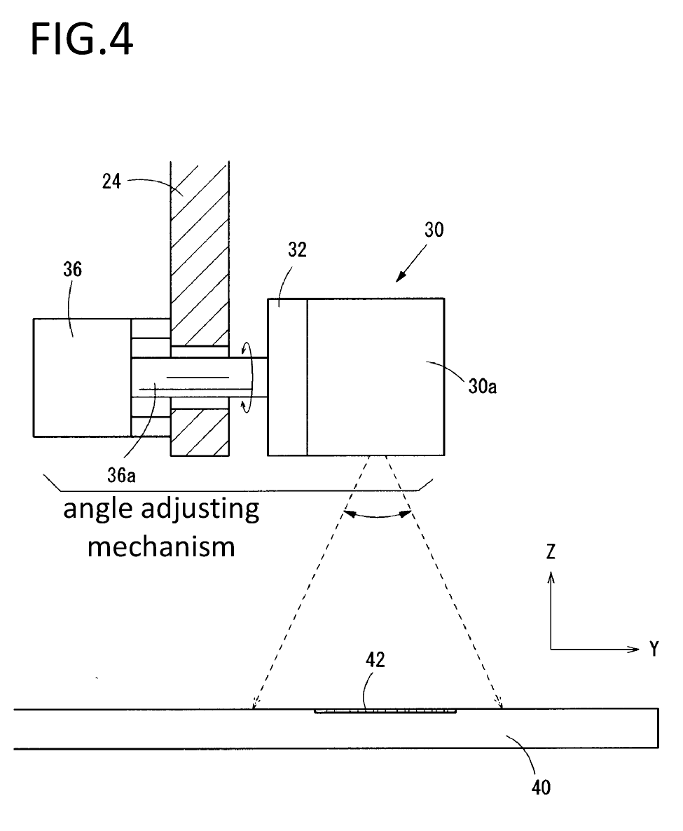

FIG. 4 shows a mounting mechanism for the barcode reading unit 30. A motor 36 is fixed to the rear side of the supporting plate 24, and a driving shaft 36a of the motor 36 is rotatably supported to the supporting plate 24. A mounting plate 32 is fixed at the end of the driving shaft 36a. The main body 30a of the barcode reading unit 30 is fixed to the mounting plate 32, and a reading angle of the barcode reading unit 30 is adjusted by driving the motor 36.

In this embodiment, the motor 36, the mounting plate 32, the supporting plate 24, and the like constitute an angle adjusting mechanism of the barcode reading unit 30. The reading angle of the barcode reading unit 30 is adjusted by driving the motor 36 under the control of a control unit 28. The above structure in which the barcode reading unit 30 is directly connected the driving shaft 36a of the motor 36 is just an example of the angle adjusting mechanism for adjusting the reading angle of the barcode reading unit 30, and the angle adjusting mechanism of the barcode reading unit 30 is not limited to the above structure.

Here, the reading angle θ of the barcode reading unit 30 refers to an angle between laser light irradiation direction and a straight line (0°) extending downward in a vertical direction from the center (rotation center position) of the barcode reading unit 30 as shown in FIG. 3.

FIG. 3 shows a state in which the barcode reading unit 30 is adjusted to the reading position for a barcode 42 formed on the substrate 40 placed in the setting unit 16. The barcode reading unit 30 scans a barcode with laser light in the longitudinal direction of the barcode and detects reflected light to identify a barcode pattern. Here, the longitudinal direction of the barcode refers to a direction orthogonal to (direction crossing) a direction in which a pattern line of the barcode extends.

Since the barcode reading unit 30 sets a reading angle θ at the time of reading a barcode, the barcode reading unit 30 emits laser light diagonally to the surface of the substrate 40 to thereby perform a reading operation.

The operation of the barcode reading unit 30 for adjusting the reading angle θ is realized by driving the motor 36 to rotate the barcode reading unit 30 about an axial line of the driving shaft 36a. This operation is to rotate the barcode reading unit 30 within a plane orthogonal to the longitudinal direction of the barcode, in other words, to rotate the barcode reading unit 30 within a plane vertical to a surface scanned with laser light emitted from the barcode reading unit 30.

The main body 30a of the barcode reading unit 30 accommodates a laser light source such as a semiconductor laser and a light receiving element for receiving reflected light from a barcode. Laser light emitted from the laser light source is reflected by a mirror or prism so as to scan a barcode surface. A barcode pattern is identified based on reflected light received with the light receiving element. As for scanning with laser light, either single laser light or plural laser light beams may be used.

In the substrate processing apparatus, after the substrate 40 is set in the setting unit 16, the barcode 42 detects the barcode 42 formed on the substrate 40 with the barcode reading mechanism, and the router processing unit 20 separates the substrate into plural substrates.

The barcode reading mechanism of this embodiment includes the barcode reading unit 30, the X driving mechanism and the Y driving mechanism as moving mechanisms that define an in-plane movement position of the barcode reading unit 30, the mechanism for adjusting the angle of the barcode reading unit 30, and the control unit 28 for controlling the moving mechanism and the angle adjusting mechanism (see FIG. 2).

### (Barcode Reading Method)

An operation of reading a barcode with the above substrate processing apparatus is performed under such a condition that the substrate 40 is set in the setting unit 16.

After the substrate 40 has been set in the setting unit 16, the moving mechanisms (the X driving mechanism 27a and 27b) are controlled to adjust the barcode reading unit 30 to a barcode reading position. Since a formation position of the barcode 42 on the substrate 40 is preset in accordance with a product (product type), the moving mechanisms are automatically driven under the control of the control unit 28 to thereby adjust the barcode reading unit 30 to the barcode reading position.

As shown in FIG. 3, if laser light is emitted from the barcode reading unit 30 diagonally to the surface of the substrate 40, the barcode reading unit 30 is displaced from a position right above the barcode 42. Here, a vertical (Z-directional) distance between the substrate 40 and the barcode reading unit 30 influences adjustment of the reading position and barcode reading accuracy. In this embodiment, the reading operation is executed with the height position (Z-directional position) of the barcode reading unit 30 being fixed to a preset height.

After adjusting the barcode reading unit 30 to the reading position, an operation of reading the barcode 42 is started. As for a general reading operation, the barcode 42 is read with the barcode reading unit 30 being adjusted to the barcode 42. In this embodiment, a barcode is read through the following processing because a barcode formed on the substrate is difficult to read in some cases and reading conditions vary from one product to another.

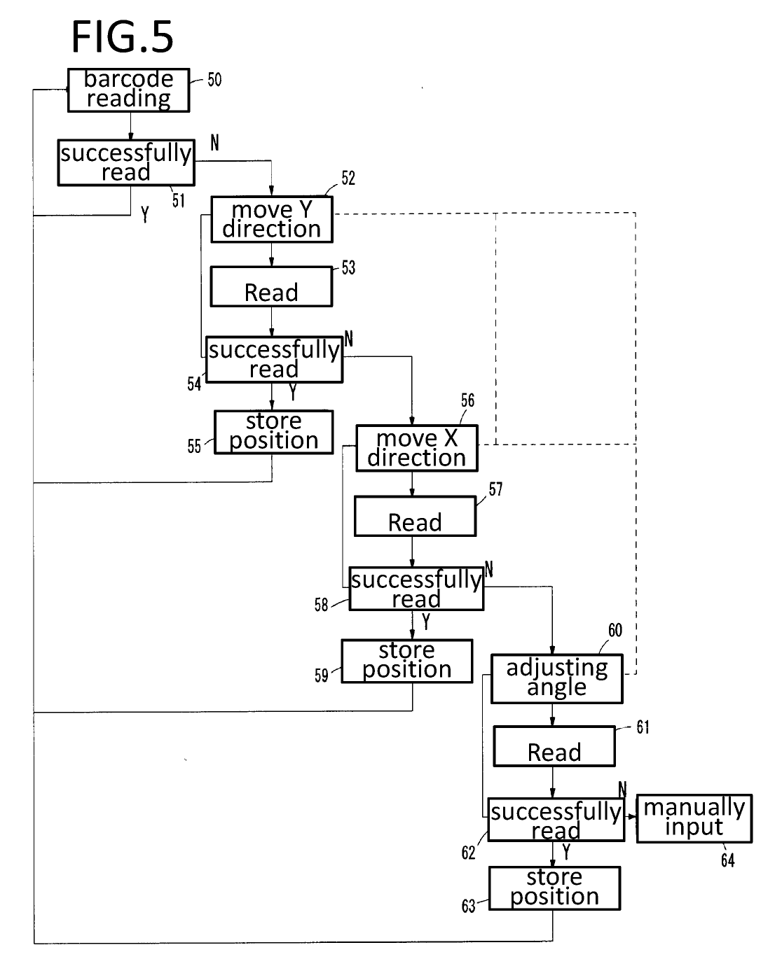

FIG. 5 is a flowchart of the barcode reading method of this embodiment.

First, in step 50, a barcode is read. In step 51, it is determined whether the barcode is successfully read. In step 51, if the barcode is successfully read, the barcode reading processing is completed, and a reading step for the next substrate is started.

In step 51, if the barcode cannot be read, the control unit 28 controls the Y driving mechanism 27b to move the barcode reading unit 30 in the Y direction to advance the processing to the barcode reading processing. During this operation, the barcode reading unit 30 is moved in the Y direction (step 52), the barcode is read in the movement position (step 53), and whether the barcode is successfully read is determined (step 54).

To specifically explain the operation of moving the barcode reading unit 30 in the Y direction to determine whether the barcode is successfully read, the barcode reading unit 30 is moved bit by bit, and it is determined whether the barcode is successfully read in the movement position. The operation of moving the barcode reading unit 30 in the Y direction is to move the barcode reading unit 30 in the front-to-back direction of the apparatus (lateral direction in FIG. 4). This operation corresponds to an operation of displacing the barcode reading unit 30 in parallel to the longitudinal direction of the barcode.

As a result of shifting a laser light irradiation range toward the Y direction and applying laser light to a position shifted to the Y direction, the barcode could be easily read in some cases. The barcode reading unit 30 is moved in the Y direction to execute scanning for that reason.

If the barcode reading unit 30 moved to the Y direction successfully reads the barcode (step 54), the Y-coordinate position is stored (step 555), and the next barcode reading operation starts from the Y-coordinate position.

If the barcode cannot be read in step 54, the X driving mechanism 27a moves the barcode reading unit 30 in the X direction under the control of the control unit 28 to start the barcode reading processing.

To move the reading unit in the X direction (lateral direction in FIG. 3) corresponds to an operation of slightly shifting an irradiation position of laser light for the barcode 42 toward the width direction of the barcode, in other words, the operation of shifting the barcode reading unit 30 parallel to the width direction of the barcode. The barcode 42 could be easily read if the irradiation position of laser light for the barcode 42 is moved to the width direction of the barcode, depending on a formation state of the barcode or a substrate surface state.

Upon this processing, the barcode reading unit 30 is slightly moved in the X direction (step 56) and then the reading operation is performed (step 57). In step 58, if the barcode is successfully read, corresponding X-coordinate and Y-coordinate positions are stored (step 59), and the next barcode reading operation starts from the X-coordinate and Y-coordinate positions.

If the barcode cannot be read even after the movement toward the X direction, the operation of moving the unit in the Y direction in step 52 is performed in combination with this movement operation to determine whether the barcode is successfully read. If the barcode is successfully read as a result of combining the Y-directional movement and the X-directional movement, X-coordinate and Y-coordinate positions at the reading position are stored (step 59), and the next barcode reading operation starts from the X-coordinate and Y-coordinate positions.

In step 58, it is determined that the barcode cannot be read, the control unit 28 controls the motor 36 of the angle adjusting mechanism to rotate the barcode reading unit 30 to start processing for adjusting the reading angle (step 60).

The operation of rotating the barcode reading unit 30 to adjust the reading angle is completed by repeatedly performing an operation of slightly changing the reading angle θ of the barcode reading unit 30 (step 61) and determining whether the barcode is successfully read (step 62).

If the barcode is successfully read as a result of rotating the barcode reading unit 30, the reading angle θ and corresponding X-coordinate and Y-coordinate positions are stored (step 63), and the next barcode reading operation starts with the stored X-coordinate and Y-coordinate positions with the reading angle θ.

In the case of reading the barcode while changing the reading angle θ of the barcode reading unit 30, whether the barcode is successfully read can be determined by executing the operations of shifting the barcode reading unit 30 toward the X direction and the Y direction in combination.

Since it takes only a short time to determine whether the barcode is visually identified with the barcode reading unit 30, an actual reading time is a time necessary to change the reading angle θ of the barcode reading unit 30 and to move the unit in the X direction and the Y direction.

Here, if the reading angle θ of the barcode reading unit 30 is changed, the irradiation position of laser light for the substrate 40 is shifted. Thus, in the case of reading the barcode while changing the reading angle θ, the X-Y positions (mainly the X-directional position) of the barcode reading unit 30 are controlled so as to apply laser light to the barcode 42.

If the barcode cannot be read even after the change of the reading angle θ, X-directional position, and Y-directional position of the barcode reading unit 30, a product number of the substrate is visually identified. Then, the product number is manually input (step 64). To be specific, the product number or the like is input using the touch panel 19.

A feature of this embodiment resides in the operation of moving the irradiation position of laser light for the barcode to find a position where the barcode can be easily read to thereby read the barcode. According to the barcode reading method of this embodiment, even if the barcode 42 formed on the substrate 40 cannot be visually identified under uniform conditions, the barcode reading unit 30 is adjusted to a position where the barcode can be correctly read. Thus, the barcode can be correctly read. By reading the barcode in the above manner, the barcode can be correctly read even in the case where the barcode cannot be read under general reading conditions.

Further, barcode reading conditions might largely vary in different types of products. In such a case, a barcode reading condition is determined for each product to thereby correctly read a barcode.

In addition, if a lot is changed, for example, barcode reading conditions are changed even in the same product. In this case as well, reading conditions are updated to conditions adequate for the target product to thereby read the barcode under the updated conditions. In general, since barcode reading conditions do not largely vary in the same lot, previous reading conditions (θ, X-coordinate position, and Y-coordinate position) are stored, and the next reading operation starts under these conditions to enable efficient barcode reading operation.

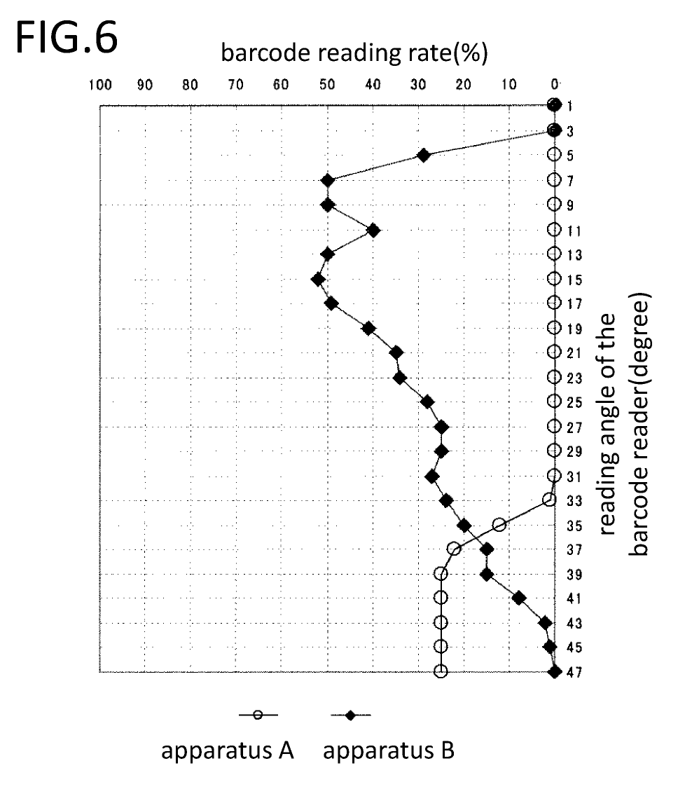

FIG. 6 shows results of actually measuring product-to-product variations in barcode reading rate with varying reading angle θ of the barcode reading unit.

The graph of FIG. 6 shows how a barcode reading rate is changed under the condition that the reading angle θ (reading angle θ in FIG. 3) varies from 0 degrees to 47 degrees. Two types of samples (resin substrates) are used upon measurement.

A sample B exhibits reading rate characteristics involved in a general product and shows a tendency that its reading rate increases at the reading angle θ of around 15 degrees, and decreases as the reading angle θ increases. To elaborate, a barcode can be easily read by setting the reading angle to about 15 degrees in a sample B.

In contrast, a sample A exhibits characteristics that the reading rate is 0% at the reading angle θ of the reading unit within the range of about 0 degrees to 30 degrees, and a barcode cannot be read, but the reading rate increases up to about 30% at the reading angle θ of more than 35 degrees and is kept at about 30% up to 47 degrees.

More specifically, it is revealed that the barcode can be easily read by setting the reading angle θ of the reading unit large as for the sample A.

The sample A is a product of high reflectivity against laser light than the sample B. As described above, the reading rate might decrease due to an influence of reflected light from a substrate in products of high reflectivity against laser light.

As described above, a wiring board covered with a resin film is not uniform in terms of a color, surface roughness, thickness, etc. of the resin film, and properties of a barcode formed through laser processing are not uniform. Hence, as a method for securely reading a barcode formed on such a substrate, it is effective to set reading conditions variable and select conditions under which a barcode can be read well to thereby read a barcode like the method of the present invention, in addition to the adjustment of the reading unit to the barcode.

In the substrate processing apparatus of the above embodiment, the X driving mechanism and Y driving mechanism for moving the router processing unit under control are also utilized to move the barcode reading unit under control. Thus, the apparatus is made compact. The barcode reading unit 30 may be supported and moved under control by a single moving mechanism in accordance with an apparatus structure.

Further, the barcode reading mechanism according to the present invention is similarly applicable to a step of reading a barcode for specifying a work in a manufacturing process for a substrate or electronic component as well as to a processing apparatus for cutting a substrate into plural substrates.

All examples and conditional language recited herein are intended for pedagogical purposes to aid the reader in understanding the invention and the concept contributed by the inventor to furthering the art, and are to be construed as being without limitation to such specifically recited examples and conditions, nor does the organization of such examples in the specification related to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A barcode reading apparatus comprising:
a barcode reader for reading a barcode;
a moving mechanism for defining a movement position of the barcode reader in a plane;
an angle adjusting mechanism for adjusting a reading angle of the barcode reader in a direction orthogonal to a longitude direction of the barcode; and
a controller for controlling the moving mechanism upon reading the barcode to adjust a position of the barcode reader to a barcode reading position, and controlling the angle adjusting mechanism in the adjusted position to adjust the reading angle of the barcode reader.

2. The barcode reading apparatus according to claim 1,
wherein the controller is further for displacing the barcode reader in parallel to the longitudinal direction of the barcode to adjust the position of the barcode reader.

3. The barcode reading apparatus according to claim 1,
wherein the controller is further for shifting the barcode reader in parallel to the width direction of the barcode to adjust the position of the barcode reader.

4. The barcode reading apparatus according to claim 2,
wherein the controller is further for shifting the barcode reader in parallel to the width direction of the barcode to adjust the position of the barcode reader.

5. A method for reading a barcode comprising:
controlling the moving mechanism upon reading the barcode to adjust a position of the barcode reader to a barcode reading position;
controlling the angle adjusting mechanism in the adjusted position to adjust the reading angle of the barcode reader in orthogonal to the longitudinal direction of the barcode;
reading the barcode after adjusting the position of the barcode reader and adjusting the reading angle of the bar code reader;
storing the position of the barcode reader and setting a next starting position to stored the position of the barcode reader.

6. The method for reading a barcode according to claim 5, further comprising:
displacing the barcode reader in parallel to the longitudinal direction of the barcode to adjust the position of the barcode reader and shifting the barcode reader in parallel to the width direction of the barcode to adjust the position of the barcode reader after the controlling the moving mechanism upon reading the barcode to adjust a position of the barcode reader to a barcode reading position.

7. A substrate processing apparatus comprising:
an apparatus for reading a barcode on a substrate,
wherein the apparatus comprises:
a barcode reader for reading a barcode;
a moving mechanism that defines a movement position of the barcode reader in a plane;
an angle adjusting mechanism for adjusting a reading angle of the barcode reader in a direction orthogonal to a longitude direction of the barcode; and
a controller for controlling the moving mechanism upon reading the barcode to adjust a position of the barcode reader to a barcode reading position, and controlling the angle adjusting mechanism in the adjusted position to adjust the reading angle of the barcode reader.

8. The substrate processing apparatus according to claim 7, further comprising:
a router processing unit for processing the substrate, being supported by the moving mechanism,
wherein the controller is further for controlling the moving mechanism to adjust the router processing unit to a substrate processing position.
